(19) United States
(12) Patent Application Publication
(10) Pub. No.: US 2014/0150023 A1
(43) Pub. Date: May 29, 2014

(54) CONTEXTUAL USER INTERFACE

(71) Applicants: Gregory David Gudorf, Los Angeles, CA (US); Kenneth Alan Rudman, South Pasadena, CA (US); Vasil Nadzakov, Los Angeles, CA (US); Andrew Yoon, Los Angeles, CA (US); Roger Yeh, San Marino, CA (US); Basil Badawiyeh, Santa Claria, CA (US); Genevieve Marie Pinvidic, Paris (FR); Dana Forte, Castaic, CA (US); Dan Han Diep, San Gabriel, CA (US); Samir M Ahmed, Glendale, CA (US); Lee Douglas Shartzer, Valencia, CA (US); John Frederick Bishop, Santa Monica, CA (US); James Earl Booth, JR., Burbank, CA (US); Hao Chi Tran, El Monte, CA (US); Peter S Lee, Calabasas Park, CA (US); Jason Douglas Pickersgill, Los Angeles, CA (US); Mark Leroy Walker, Castaic, CA (US); David Pettigrew, San Francisco, CA (US)

(72) Inventors: Gregory David Gudorf, Los Angeles, CA (US); Kenneth Alan Rudman, South Pasadena, CA (US); Vasil Nadzakov, Los Angeles, CA (US); Andrew Yoon, Los Angeles, CA (US); Roger Yeh, San Marino, CA (US); Basil Badawiyeh, Santa Claria, CA (US); Genevieve Marie Pinvidic, Paris (FR); Dana Forte, Castaic, CA (US); Dan Han Diep, San Gabriel, CA (US); Samir M Ahmed, Glendale, CA (US); Lee Douglas Shartzer, Valencia, CA (US); John Frederick Bishop, Santa Monica, CA (US); James Earl Booth, JR., Burbank, CA (US); Hao Chi Tran, El Monte, CA (US); Peter S Lee, Calabasas Park, CA (US); Jason Douglas Pickersgill, Los Angeles, CA (US); Mark Leroy Walker, Castaic, CA (US); David Pettigrew, San Francisco, CA (US)

(73) Assignee: Thomson Licensing, Issy-les Moulineaux (FR)

(21) Appl. No.: 13/978,107

(22) PCT Filed: Jan. 4, 2012
(86) PCT No.: PCT/US12/20124

§ 371 Date: Feb. 11, 2014

Related U.S. Application Data
(60) Provisional application No. 61/429,732, filed on Jan. 4, 2011.

(51) Int. Cl. H04N 21/41; H04N 21/2665; H04N 21/462; H04N 21/422

(52) U.S. Cl. CPC H04N 21/4126; H04N 21/42224; H04N 21/2665; H04N 21/4622
USPC 725/38

(57) ABSTRACT

The present disclosure is directed towards having a user interface being selected for display on an input device to control the playback of a media asset or media service. A determination is made of the media asset or media service to be played and a lookup operation is performed to select the corresponding user interface for the input device. The user interface will change depending on the media asset or media service being selected for playback.

### CROSS REFERENCE TO RELATED APPLICATIONS

This application claims the benefit of U.S. Provisional Application Ser. No. 61/429,732 filed on Jan. 4, 2011 which is incorporated by reference herein in their entirety.

### TECHNICAL FIELD

A user interface is used to control a media player that plays back a media asset. More particularly, the present disclosure is for a method for selecting an appropriate user interface for an input device when controlling the playback of a media asset through a media player.

### BACKGROUND OF THE DISCLOSURE

When controlling the playback of a media asset and/or a media service, a user can use an input device that displays a user interface to control such a playback operation. It is impractical however to use the same user interface for the playback of all media assets because sources of such media assets can be different. For example, when tuning to a channel broadcast for an ATSC based video transmission, a tuner is controlled by using two-part numbers to receive a video based media asset. However, such use of two-part numbers to access or control a media asset using NETFLIX is not appropriate since NETFLIX does not use a tuner or a terrestrial based broadcast channel.

### SUMMARY

A method and an apparatus are presented where an appropriate media player mode is selected for playing back a media asset or media service. The selection of the media player mode then is linked to determining a user interface that is used to control such a playback operation using an input device. The user interface is then presented on the input device which can be used by a user for controlling the playback of a media asset or media service.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary system for delivering content in accordance with the present disclosure;

FIG. 2 is a block diagram of an exemplary set-top box/digital video recorder (DVR) as a media device in accordance with the present disclosure;

FIG. 3 is a perspective view of an exemplary media device in accordance with an embodiment of the present disclosure;

FIG. 4 illustrates an exemplary embodiment of the use of a gestures for a sensing controller or touch screen in accordance with the present disclosure;

FIG. 5 shows an exemplary embodiment of a user interface in accordance with the present disclosure;

FIG. 6 shows an exemplary embodiment of a user interface in accordance with the present disclosure;

FIG. 7 shows an exemplary embodiment of a user interface in accordance with the present disclosure;

FIG. 8 shows an exemplary embodiment of a user interface in accordance with the present disclosure;

FIG. 9 shows an exemplary embodiment of a user interface in accordance with the present disclosure;

FIG. 10 shows an exemplary embodiment of a user interface in accordance with the present disclosure;

FIG. 11 shows an exemplary embodiment of a user interface in accordance with the present disclosure;

FIG. 12 shows an exemplary embodiment of a flowchart indicating a selection of a user interface for an input device based on a media asset being played back in accordance with the present disclosure; and

FIG. 13 shows an exemplary embodiment of a user interface in accordance with the present disclosure.

### DETAILED DESCRIPTION

The present disclosure provides several different embodiments of a user interface that is used for receiving, recording, playing back, purchasing, and the like media such as videos, television shows, movies, audio, music, video games, and the like. Such a user interface can be implemented on devices such as a computer, set top box, media server, tablet, mobile phone, personal media, device, portable video game system, video game system, and so forth.

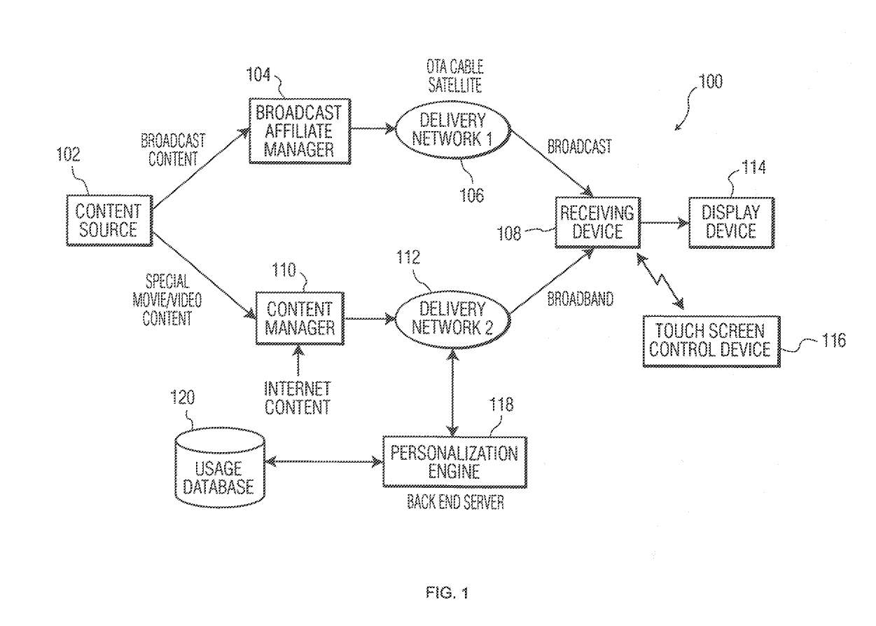

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a media device 108 in a user's home, where the content will subsequently be searched by the user. It is to be appreciated that the media device 108 can take many forms and may be embodied as a set top box/digital video recorder (DVR), a gateway, a modem, etc. Further, the media device 108 may act as entry point, or gateway, for a home network system that includes additional devices configured as either client or peer devices in the home network.

A second form of content is referred to as special content. Special content may include content delivered as premium viewing, pay-per-view, or other content otherwise not provided to the broadcast affiliate manager, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's media device 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In addition, the user may also obtain content directly from the Internet via delivery network 2 (112) without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

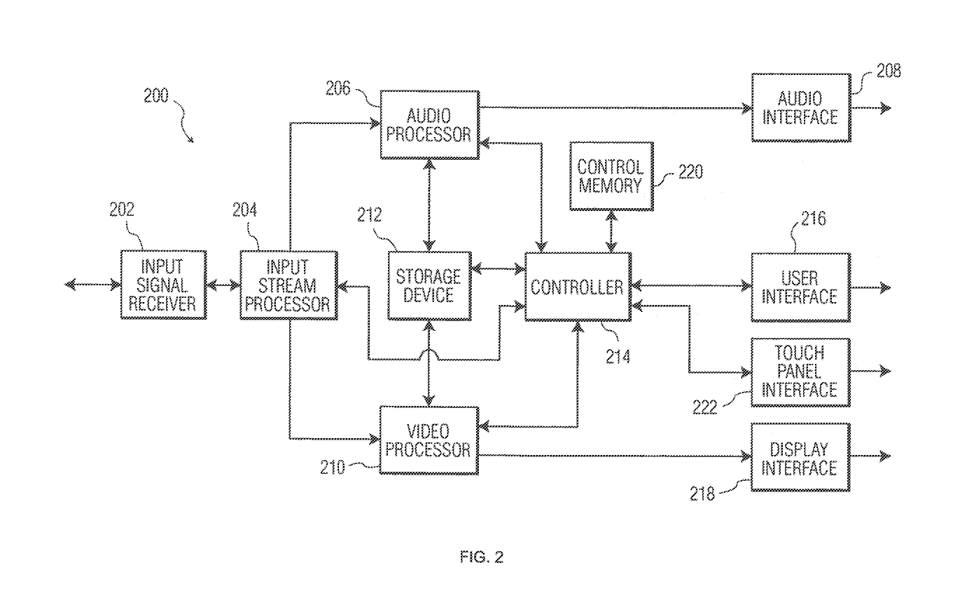

The media device 108 may receive different types of content from one or both of delivery network 1 and delivery network 2. The media device 108 processes the content, and provides a separation of the content based on user preferences and commands. The media device 108 may also include a storage device, such as a hard drive or optical disk drive, for recording and playing back audio and video content. Further details of the operation of the media device 108 and features associated with playing back stored content will be described below in relation to FIG. 2. The processed content is provided to a display device 114. The display device 114 may be a conventional 2-D type display or may alternatively be an advanced 3-D display.

The media device 108 may also be interfaced to a second screen such as a touch screen control device 116 as an input device. The touch screen control device 116 may be adapted to provide user control for the media device 108 and/or the display device 114. The touch screen device 116 may also be capable of displaying video content. The video content may be graphics entries, such as user interface entries, or may be a portion of the video content that is delivered to the display device 114 The touch screen control device 116 may interface to media device 108 using any well known signal transmission system, such as infra-red (IR) or radio frequency (RF) communications and may include standard protocols such as infra-red data association (IRDA) standard, Wi-Fi, Bluetooth and the like, or any other proprietary protocols. Operations of touch screen control device 116 will be described in further detail below.

Optionally, media device 108 and touch screen control device 116 can be integrated into the same device. Examples of these media devices with a touch screen include computers, laptops, cell phones, personal media player, MP3 players, personal desk assistants, tablet devices, digital video recorders, and the like. For purposes of this specification, the term media device 108 can encompass all of these types of devices.

In the example of FIG. 1, the system 100 also includes a back end server 118 and a usage database 120. The back end server 118 includes a personalization engine that analyzes the usage habits of a user and makes recommendations based on those usage habits. The usage database 120 is where the usage habits for a user are monitored and information about such usage habits is stored. It is possible to use such user habit information to develop a profile for a user which is then used for recommending advertisements and programming. In some cases, the usage database 120 may be part of the back end server 118. In the present example, the back end server 118 (as well as the usage database 120) is connected to the system the system 100 and accessed through the delivery network 2 (112).

Turning now to FIG. 2, a block diagram of an embodiment of a media device 200 is shown. Receiving device 200 may operate similar to the media device described in FIG. 1 and may be included as part of a gateway device, modem, set-top box, or other similar communications device. The device 200 shown may also be incorporated into other systems including an audio device or a display device. In either case, several components necessary for complete operation of the system are not shown in the interest of conciseness, as they are well known to those skilled in the art.

In the device 200 shown in FIG. 2, the content is received by an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface or touch panel interface 222. Touch panel interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or touch panel interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results in a three dimensional gird as will be described in more detail below.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the gird display representing the content, either stored or to be delivered via the delivery networks, described above.

The controller 214 is further coupled to control memory 220 (e.g., volatile or nonvolatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory may also store a database of elements, such as graphic elements containing content, various graphic elements used for generating a displayed user interface for display interface 218, and the like. Alternatively, the memory may store the graphic elements in identified or grouped memory locations and use an access or location table to identify the memory locations for the various portions of information related to the graphic elements. In addition, various graphic elements can be generated in response to computer instructions interpreted by controller 214 for output to display interface 218. Additional details related to the storage of the graphic elements will be described below. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

Optionally, controller 214 can be adapted to extract metadata from audio and video media by using audio processor 206 and video processor 210, respectively. That is, metadata that is contained in video signal in the vertical blanking interval, auxiliary data fields associated with video, or in other areas in the video signal can be harvested by using the video processor 210 with controller 214 as to generate metadata that can be used for functions such as generating an electronic program guide, have descriptive information about received video, supporting an auxiliary information service, and the like. Similarly, the audio processor 206 working with controller 214 can be adapted to recognize audio watermarks that may be in an audio signal. Such audio watermarks can then be used to perform some action such as the recognition of the audio signal, security which identifies the source of an audio signal, or perform some other service. Furthermore, metadata to support the actions listed above can come from a network source which are processed by controller 214.

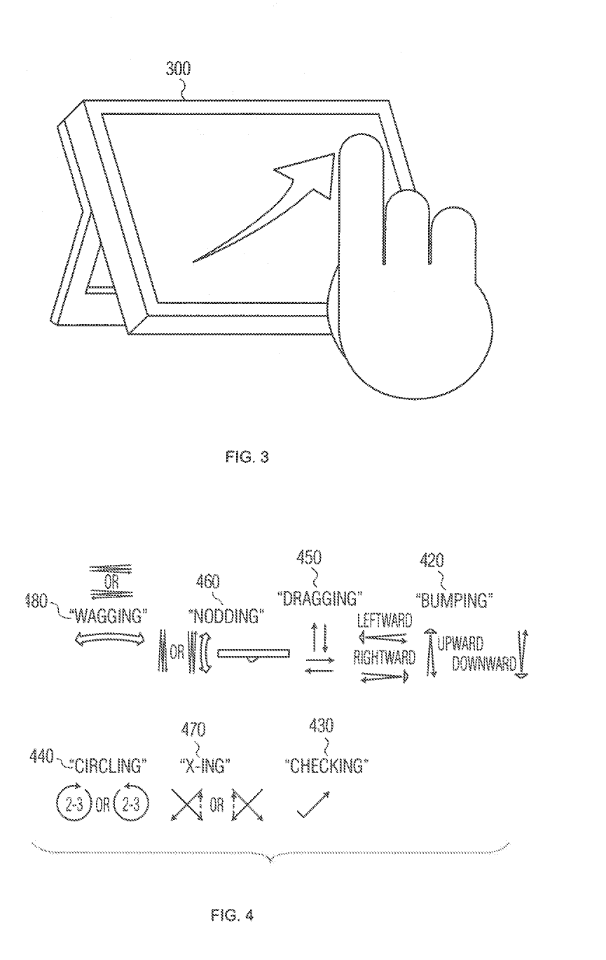

Turning now to FIG. 3, the user interface process of the present disclosure employs an input device that can be used to express functions, such as fast forward, rewind, etc. To allow for this, a tablet or touch panel device 300 (which is the same as the touch screen device 116 shown in FIG. 1 and/or is an integrated example of media device 108 and touch screen device 116) may be interfaced via the user interface 216 and/or touch panel interface 222 of the receiving device 200. The touch panel device 300 allows operation of the receiving device or set top box based on hand movements, or gestures, and actions translated through the panel into commands for the set top box or other control device. In one embodiment, the touch panel 300 may simply serve as a navigational tool to navigate the grid display or means that controls a second device via a user interface. In other embodiments, the touch panel 300 will additionally serve as the display device allowing the user to more directly interact with the navigation through the grid display of content. The touch panel device may be included as part of a remote control device containing more conventional control functions such as activator buttons. The touch panel 300 can also includes at least one camera element.

Turning now to FIG. 4, the use of a gesture sensing controller or touch screen, such as shown, provides for a number of types of user interaction. The inputs from the controller are used to define gestures and the gestures, in turn, define specific contextual commands. The configuration of the sensors (e.g., touch screen sensors and/or inertial sensors such as accelerators and/or gyroscopic sensors) may permit defining movement of a user's fingers on a touch screen or may even permit defining the movement of the controller itself in either one dimension or two dimensions. Two-dimensional motion, such as a diagonal, and a combination of yaw, pitch and roll can be used to define any three-dimensional motion, such as a swing. A number of gestures are illustrated in FIG. 4. Gestures are interpreted in context and are identified by defined movements made by the user.

Bumping 420 is defined by a two-stroke drawing indicating pointing in one direction, either up, down, left or right. The bumping gesture is associated with specific commands in context. For example, in a TimeShifting mode, a left-bump gesture 420 indicates rewinding, and a right-bump gesture indicates fast-forwarding. In other contexts, a bump gesture 420 is interpreted to increment a particular value in the direction designated by the bump. Checking 440 is defined as in drawing a checkmark. It is similar to a downward bump gesture 420. Checking is identified in context to designate a reminder, user tag or to select an item or element. Circling 440 is defined as drawing a circle in either direction. It is possible that both directions could be distinguished. However, to avoid confusion, a circle is identified as a single command regardless of direction. Dragging 450 is defined as an angular movement of the controller (a change in pitch and/or yaw) while pressing a button (virtual or physical) on the tablet 300 (i.e., a “trigger drag”). The dragging gesture 450 may be used for navigation, speed, distance, time-shifting, rewinding, and forwarding. Dragging 450 can be used to move a cursor, a virtual cursor, or a change of state, such as highlighting outlining or selecting on the display. Dragging 450 can be in any direction and is generally used to navigate in two dimensions. However, in certain interfaces, it is preferred to modify the response to the dragging command For example, in some interfaces, operation in one dimension or direction is favored with respect to other dimensions or directions depending upon the position of the virtual cursor or the direction of movement. Nodding 460 is defined by two fast trigger-drag up-and-down vertical movements. Nodding 460 is used to indicate “Yes” or “Accept.” X-ing 470 is defined as in drawing the letter “X.” X-ing 470 is used for “Delete” or “Block” commands. Wagging 480 is defined by two trigger-drag fast back-and-forth horizontal movements. The wagging gesture 480 is used to indicate “No” or “Cancel.”

Depending on the complexity of the sensor system, only simple one dimensional motion or gestures may be allowed. For instance, a simple right or left movement on the sensor as shown here may produce a fast forward or rewind function. In addition, multiple sensors could be included and placed at different locations on the touch screen. For instance, a horizontal sensor for left and right movement may be placed in one spot and used for volume up/down, while a vertical sensor for up and down movement may be place in a different spot and used for channel up and down. In this way specific gesture mappings may be used.

When using a media asset (video, audio, picture, game) and/or a media service (such as FACEBOOK, NETFLIX, HULU, PANDORA and the like) a display device, a user using a tablet or other type of input device to control the playback of the media service can be presented with different user interfaces which are displayed on the input device itself. That is, an input device controls the operation of a main device (e.g., computer, set top box, media device, display device itself, and the like) when playing a media asset where a user enters commands via such user interfaces which affect the playback of a media service. Exemplary embodiments therefore provide various embodiments of user interfaces that change context depending on the media service being accessed for playback.

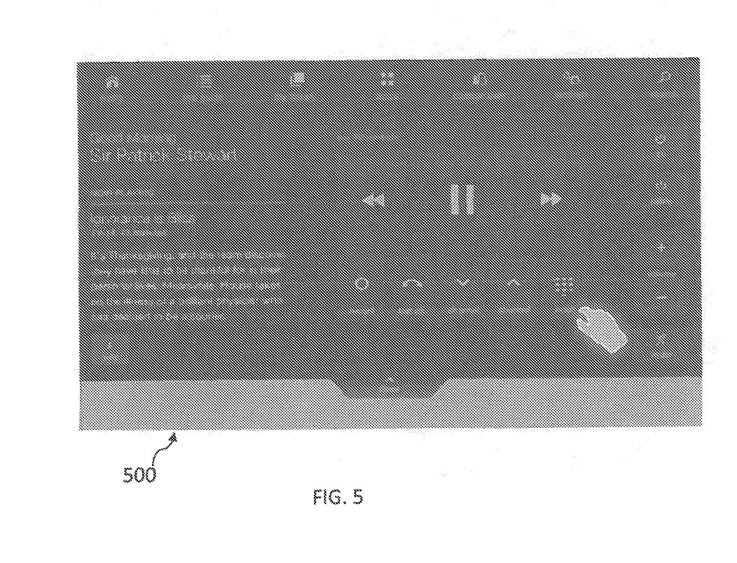

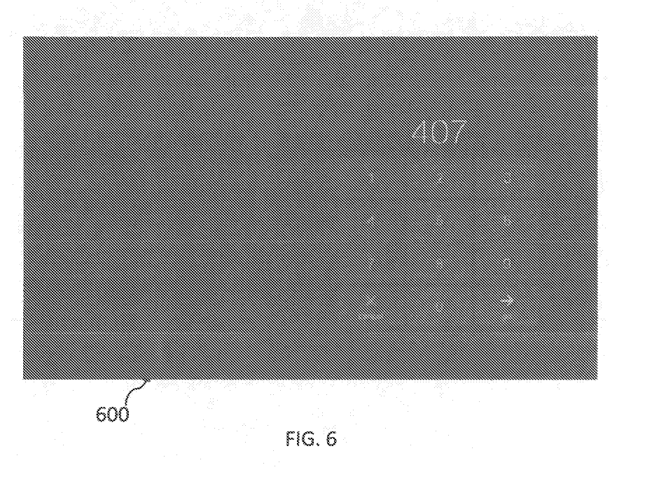

FIG. 5 displays an illustrative embodiment of a user interface 500 that allows a user to select various broadcast services. Such a user interface is brought up when the user is watching live broadcast as a media asset on a main device. FIG. 6 shows an example of a user interface 600 lets a user to select a specific channel for a live broadcast as a media service. This type of input can change to accommodate an ATSC over the air source (major/minor channels) and satellite/cable television which can be implemented without minor channels being necessary.

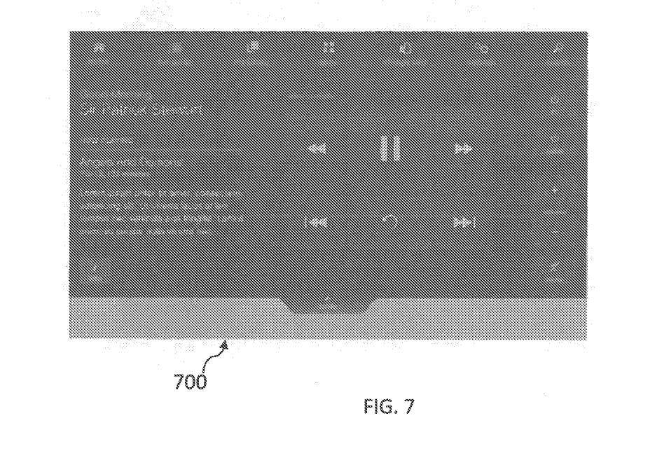

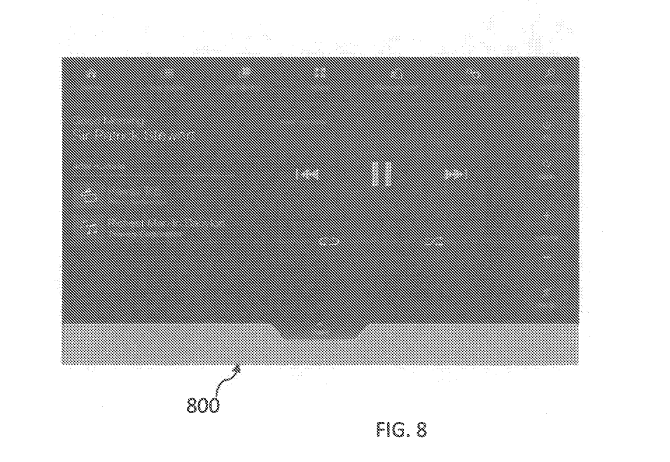

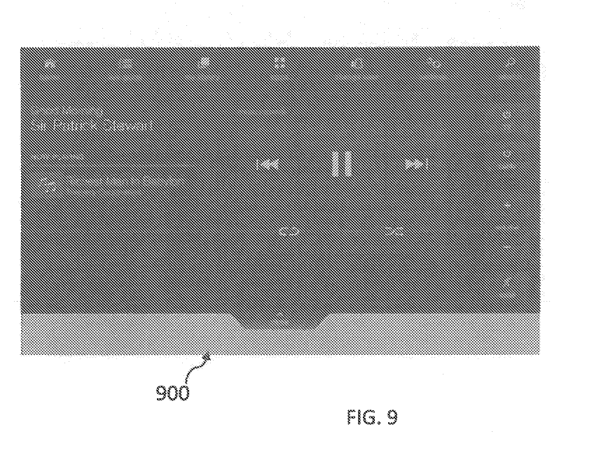

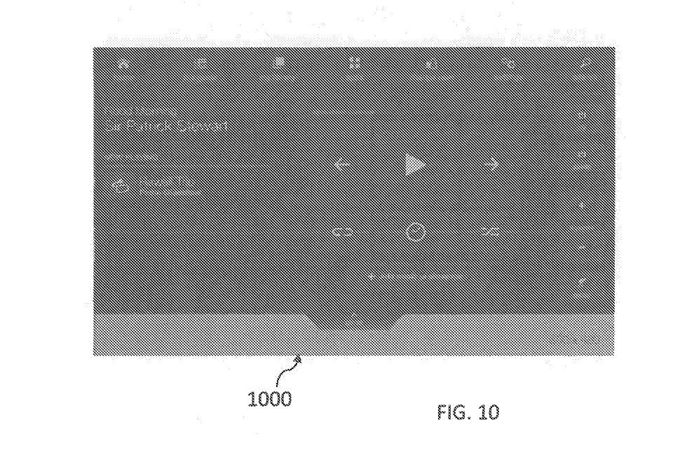

If a user is watching recorded content that is stored on a DVR, delivered through a streaming video service, or as video on demand, a user can be presented with an exemplary embodiment of user interface 700 as in FIG. 7 on the input device. The displayed control interface lets the user control the playback and trick play functions of the recorded content using the various arrow keys, play button, pause button, stop button, and the like as shown. If a user is watching a picture slide show on a main device, the user can be presented an exemplary embodiment of user interface 800 of FIG. 8, which controls the music playback that is used during such a slide show. That is, a user can select the music to be used while various graphic images are shown on the main screen. FIG. 9 displays an exemplary embodiment of a user interface 900 that can be used for controlling the music playback of audio. FIG. 10 displays an exemplary embodiment of a user interface 1000 for a slide show which does not have music in the background.

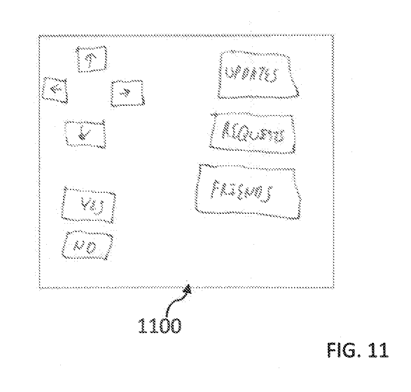

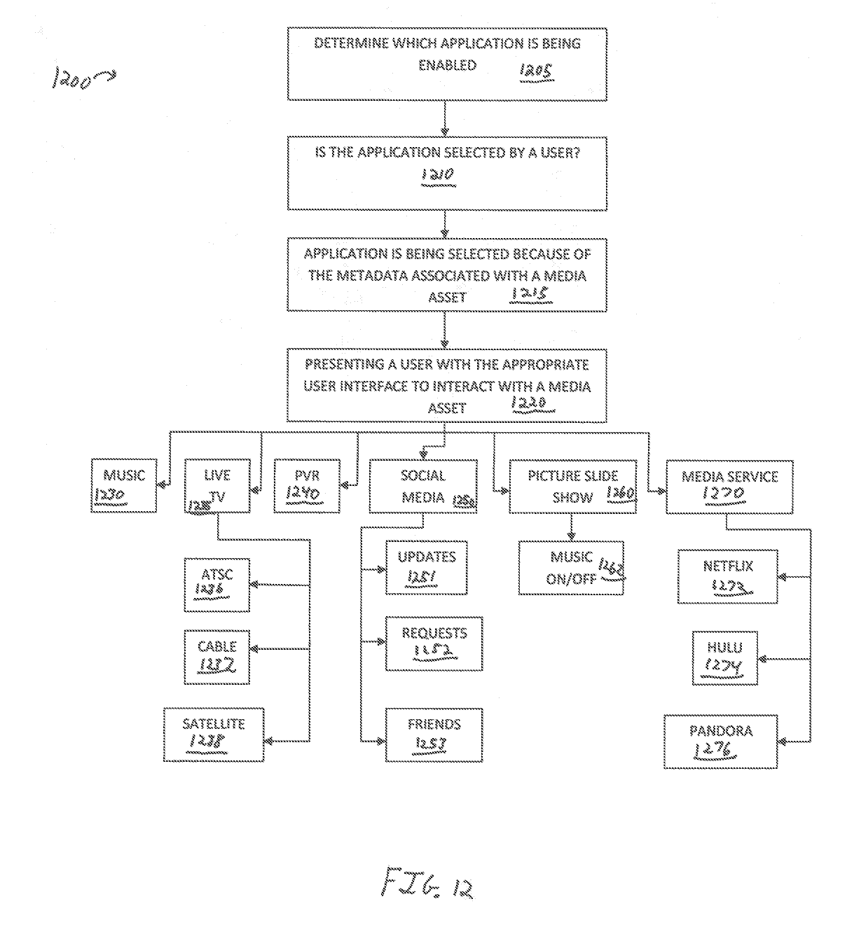

The presentation of having different user interfaces displayed on a user input device can also be affected when accessing an application that is being viewed on a display device. For example, when accessing a social networking service such as FACEBOOK as an application on a display device, a user input device can display an appropriate user interface to control the main screen. FIG. 11 presents an exemplary embodiment of user interface 1100 that presents four directional buttons (up/down/left/right), a yes/no option, and areas that comport to different aspects of the social networking service such as updates, requests, friends, and the like. The selection of any of these options while using an input device would be reflected in what is shown on the display device in accordance with the principles of the present disclosure.

An exemplary embodiment of the disclosure allows for the device that is playing a media service to communicate with the input device to indicate what user interface the input device should provide a user. In one embodiment, exemplifying a push methodology, the input device has stored in a memory a number of different menus where each menu is linked to a specific name such as MENU1, MENU2, MENU3 . . . MENUX (x=a number). The device playing back the media service will send a command to the input device such as DISPLAY MENU2 to the input device to select the user interface associated with MENU2.

In another exemplary embodiment, illustrating a push methodology, an input device makes use of a browser such as INTERNET EXPLORER, SAFARI, MOZILLA, FIREFOX, CHROME, and the like. A playback device can send formatting commands in accordance with HyperText Markup Language (HTML), JAVA programming language, and the like, to the browser running on the input device whereby the formatting commands are used to generate a user interface. The rendered user interface presented on the input device can be used to send control commands back to the playback device.

In an exemplary embodiment, illustrating a pull methodology, an input device, in response to a user command to playback a specific media asset or an activation to select a specific media mode (e.g., broadcast television, video on demand, streaming media, and the like) presents the appropriate user interface for playing the selected asset or media mode. The input device then instructs a display device and/or media playback device to activate the appropriate media asset or media mode.

TABLE 1 presents an illustrative embodiment where a device such as a player device determines what program mode will be required to playback a media asset or media service using metadata that is associated with the media asset or media service. For example, the player device can have an internal table that indicates what program is to be called when a particular file extension or keyword indicated in quotes is associated with a media file. Such metadata can be analyzed by looking at a media asset's file wrapper, file extension, associated descriptor, and recognition of command format associated with a particular media asset and/or media service, metadata indicating a source of a media asset and/or media service, Multipurpose Internet Mail Extensions (MIME) metadata, and the like. Once the appropriate media player program or mode is selected, a command from the media player to the input selecting the appropriate menu is issued in accordance with the information show in TABLE 1. Other implementations of how to associate a menu with media asset being played back and/or media service can be implemented in accordance with the disclosed exemplary embodiments.

TABLE 1

| | MEDIA PLAYER | |
|---|---|---|
| | PROGRAM/MEDIA | |
| | SERVICE/MEDIA | MENU |
| METADATA | PLAYER MODE | SELECTED |
| H.264, H.265, VC-1, | RECORDED VIDEO | MENU 1 |
| MPEG-2 VIDEO, “VIDEO” | PROGRAM | |
| AC3, MP3, FLAC, WMV, | AUDIO PROGRAM | MENU 2 |
| “AUDIO” | | |
| .JPG, .BMP, .PNG, | SLIDESHOW PROGRAM | MENU 3 |
| “PICTURE” | | |
| FRIENDREQUEST, | FACEBOOK USER | MENU 4 |
| FRIENDMESSAGE, | INTERFACE | |
| FRIENDINVITE, | | |
| “FACEBOOK”, | | |
| FACEBOOK COMMAND | | |
| FORMAT | | |
| NETFLIX COMMAND | NETFLIX USER | MENU 5 |
| FORMAT, “NETFLIX” | INTERFACE | |
| PVR COMMAND | PVR USER INTERFACE | MENU 6 |
| FORMAT, “PVR” | | |

TABLE 2 presents examples of exemplary commands that can be issued between an input device and a device that plays media assets. Some of these commands include trick play functions aside for regular commands. It is noted that a command “SELECT_MENU” is presented which provides that an input device and a media asset player device can issue a command commands between each other to select an appropriate user interface in accordance with an exemplary embodiment.

TABLE 2

| ACTION_TYPE_ID | ACTION_TYPE |
|---|---|
| 0 | UNKNOWN |
| 1 | APPLICATION_START |
| 2 | APPLICATION_END |
| 3 | SCREENSAVER_START |
| 4 | SCREENSAVER_END |
| 5 | ACQUIRE |
| 6 | SEARCH |
| 7 | SHARE |
| 8 | MANAGE_FRIEND |
| 9 | MANAGE_LIBRARY |
| 10 | MIRROR |
| 11 | PLAY |
| 12 | PAUSE |
| 13 | FASTFORWARD |
| 14 | REVERSE |
| 15 | STOP |
| 16 | VIEW_TV_START |
| 17 | VIEW_TV_END |
| 18 | MANAGE_DVR_RECORDING |
| 19 | USER_ACTION |
| 20 | FILE_DOWNLOAD |
| 21 | SELECT_MENU |

FIG. 12 presents an exemplary embodiment of a flowchart 1200 illustrating a method for selecting an appropriate user interface for an input device when a media service is being played back or recorded using a media device that is controlled through the input device. In step 1205, a determination is made to find out whether an application is running on a media device. Specifically, this step is concerned about whether or not an application that is being enabled is going to be related to the playback of a media asset and/or media service. For example, a word processing program would not be a program that is generally used for playing back a media asset, while a video player program would be used for playing a video based media asset. Ideally, step 1205 will distinguish that an application being enabled is related to the recording and/or playback of a media asset, where an input device is used to control such recording and/or playback functions.

Step 1210 determination whether or not an application is being called by a user or not. Sometimes, a user using an input device tells a media device that the user wants to initiate playback of a media asset or media service. Other times, a media device will initiate playback of a media service and will need to communicate with an input device that such a playback operation is beginning. Regardless of whether a “push” or “pull” situation is taking place, an input device and a media player should know about the states of one another. Exemplary commands describe herein can provide such notifications in accordance with the illustrative disclosed principles.

The selection of a playback program can be determined relative to the metadata that is associated with a media service in step 1215. Such metadata can be matched against a listing of menus in a table, database, storage, and the like, as in TABLE 1 whereby a command for an appropriate user interface e.g., “SELECT_MENU”, can be issued to an input device in step 1220 after performing such a matching step. Other approaches for determining an appropriate menu can be practiced in accordance with the illustrate principles described herein.

Step 1230 has a user interface selected that controls the playback of music. Step 1235 produces a menu that allows one to control the playback of a live television recording while submenus for such playback are also possible including a user interface in step 1236 for a ATSC broadcast which uses two part numbers, user interface in step 1237 that is used for controlling a cable broadcast, and a user interface for a satellite broadcast in step 1238.

A menu corresponding to the playback and/or recording of content from PVR takes place in step 1240. A social media application, when enabled as a program, can have different user interfaces presented for an input device where in step 1250 a general social media user interface can be shown. Step 1251 presents a specific menu that indicates the updates that a user can receive through a social media platform, step 1252 has a user interface selected that pertains to user requests to join up as a friend, and step 1253 presents a listing of friends that a user can link to through a social media program.

Step 1260 may present a user interface that is used to control the playback of a picture slide show presentation where a user interface that controls the music playback is selected in step 1262. The selection of a user interface to control the playback of a media service is performed in step 1270. User interfaces for specific media services can also be provided such as NETFLIX in step 1272, HULU in step 1274, and PANDORA in step 1276. Other user interfaces can be selected for an input device in accordance with the described illustrative principles. It is noted that when a second media asset and/or media asset is selected, a new user interface replacing the previous user interface can be displayed on an input device to control the playback or recording of the second media asset. The replacement of user interfaces for display on an input device when a new media assets and/or media services are selected can be repeated ad infinitum.

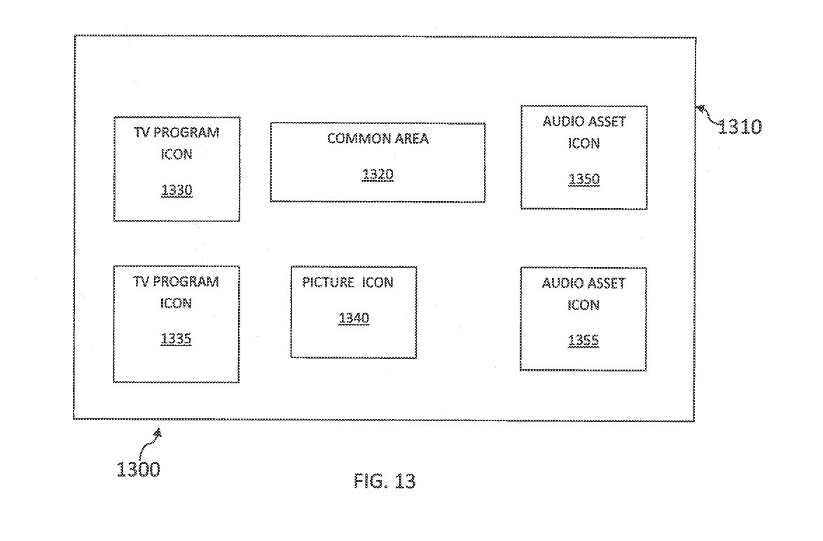

FIG. 13 presents a user interface 1300 that is used on an input device to implement that playback of a selected media asset and to then have a corresponding user interface rendered on the input device. For user interface 1300, there is a display area 1310 which shows icons as representations of different media assets including TV programs 1330, 1335, picture 1340, and audio media assets 1350, 1355. When one of these icons is dragged to common area 1320 using a display area for the input device, a media program or mode is selected for a playback device to playback a selected icon. In addition, the input device's display area will then change from the presentation shown in FIG. 13 to a new user interface that is selected to control the playback of the selected media service, in accordance with the illustrative principles described.

It is noted that the playback device and the input device can be the same device in accordance with the described embodiments.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for informational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although embodiments which incorporate the teachings of the present disclosure have been shown and described in detail herein, those skilled in the art can readily devise many other varied embodiments that still incorporate these teachings. It is noted that modifications and variations can be made by persons skilled in the art in light of the above teachings.

1. A method of selecting a user interface to control a playback of media using an input device comprising the steps of:
determining a program to be used to playing back a first media based on information associated with such media; and
selecting a user interface from a plurality of user interfaces for display on an input device, the selected user interface controls the playback of the media in response to a user command issued in response to the use of the selected user interface.

2. The method claim 1 where the information is at least one of a first media's file wrapper, a file extension associated with the first media, associated descriptor of the media, a recognition of command format associated with the first media, metadata indicating a source of the first media, and Multipurpose Internet Mail Extensions (MIME) metadata associated with the first media.

3. The method of claim 1 where the media is at least one of a media service and a media asset.

4. The method of claim 1 comprising a step of transmitting to the input device a command indicating the user interface to be selected.

5. The method of claim 1 comprising a step of displaying the user interface on the input device.

6. The method of claim 1 comprising the steps of:
determining a second program to be used for controlling the playback of the second media, in response to the selection of a second media that is different than the first media;
selecting a second user interface from the plurality of user interfaces that is different from the first user interface for display on an input device, the selected user interface controls the playback of the second media in response to a user command issued in response to the use of the selected second user interface; and
transmitting an instruction indicating that the second user interface is to be displayed by the input device.

7. The method of claim 1 where the input device is at least one of a touchpad, tablet, and an input device with a screen.

8. The method of claim 1 wherein the user interface is determined in response to a user dragging a representation of the media to a displayed common area where the first media being dragged to the common area results in a first user interface being selected for the input device and a dragging of a representation of second media to the common area results in a second user interface being selected for the media device.

9. An apparatus for selecting a user interface to control a playback of media using an input device comprising:
a means for determining a program to be used to playback a first media based on information associated with such media; and
a means for selecting a user interface from a plurality of user interfaces for display on an input device for controlling the playback of the media in response to a user command issued in response to the use of the selected user interface.

10. The apparatus claim 9 where the information is at least one of a first media's file wrapper, a file extension associated with the first media, an associated descriptor of the media, a recognition of command format associated with the first media, metadata indicating a source of the first media, and Multipurpose Internet Mail Extensions (MIME) metadata associated with the first media.

11. The apparatus of claim 9 where the media is at least one of a media service and a media asset.

12. The apparatus of claim 9 comprising a means for transmitting to the input device a command indicating the user interface to be selected.

13. The apparatus of claim 9 comprising a means for displaying the user interface on the input device.

14. The apparatus of claim 9 comprising:
a means for determining a second program to be used for controlling the playback of a second media, in response to the selection of a second media that is different than the first media;
a means for selecting a second user interface from the plurality of user interfaces that is different from the first user interface for display on an input device, the selected second user interface controlling the playback of the second media in response to a user command issued in response to the use of the selected second user interface; and
a means for transmitting an instruction indicating that the second user interface is to be displayed by the input device.

15. The input device of claim 9 where the input device is at least one of a touchpad, tablet, and an input device with a screen.

16. The apparatus of claim 9 wherein the user interface is determined in response to a user dragging a representation of the media to a displayed common area where the first media being dragged to the common area results in a first user interface being selected for the input device and a dragging of a representation of second media to the common area results in a second user interface being selected for the media device.
